(19) United States
(12) Patent Application Publication
(10) Pub. No.: US 2023/0032390 A1
(43) Pub. Date: Feb. 2, 2023

(54) ENABLERS FOR RADIO ACCESS NETWORK CONTEXT STORAGE AND RESILIENCY

(71) Applicant: NOKIA TECHNOLOGIES OY, Espoo (FI)

(72) Inventors: Devaki CHANDRAMOULI, Plano, TX (US); Rainer LIEBHART, Munich (DE)

(73) Assignee: NOKIA TECHNOLOGIES OY, Espoo (FI)

(21) Appl. No.: 17/391,255

(22) Filed: Aug. 2, 2021

(51) Int. Cl. H04W 76/11; H04W 12/0433; G06F 16/955; H04W 12/06

(52) U.S. Cl. CPC H04W 76/11; H04W 12/0433; G06F 16/955; H04W 12/06

(57) ABSTRACT

Techniques for improving the resiliency of communication networks by providing radio access network data stored in a radio access network database to one or more associated radio access network nodes are provided. A network entity receives a connection request from a user device including at least a radio access network set identifier or radio access network database identifier. The network entity determines whether the radio access network set identifier received in the connection request corresponds to an associated radio access network set identifier. In an instance in which the radio access network set identifier received in the connection request corresponds to the associated radio access network set identifier, radio access network database data are retrieved from the radio access network database associated with the radio access network set identifier. The radio access network database data include at least user device context data for the associated user device.

### TECHNOLOGICAL FIELD

An example embodiment relates generally to wireless communications and, more particularly, but not exclusively, to enablers for radio access network context storage and resiliency.

### BACKGROUND

Next generation or fifth generation (5G) technology was designed to provide high capacity mobile multimedia with high data rates and is intended to be used not only for human interaction, but also for machine type communications in so-called Internet of Things (IoT) networks. Sixth generation (6G) technology further builds off 5G technology to provide high yield increased processing speeds.

### BRIEF SUMMARY

A method, apparatus, and computer program product are disclosed for enabling radio access network context storage and resiliency. In this regard, the method, apparatus and computer program product are configured to provide a radio access network database configured to store user device context information for one or more radio access network nodes. The radio access network database may allow one or more associated radio access network nodes to obtain user device context information. As such, the need for network signaling between a RAN node and a user device, a radio access network node and an access and mobility management function, and between radio access network nodes may be reduced. Furthermore, by obtaining user device context prior to an initial context setup, a radio access network node may obtain one or more access stratum security keys and security contexts such that the radio access network node may encrypt messages to the user device earlier in the communication process, leading to enhanced security for messages between the radio access network node and a user device.

In an example embodiment, a method is provided that includes receiving, from a user device, a connection request, wherein (i) the connection request comprises at least a radio network set identifier that is indicative of at least a radio network set or a radio network database, (ii) the radio access network set identifier is indicative of a radio access network database with which a radio access network node previously connected with the user device is associated, (iii) the radio access network database is associated with one or more radio access network nodes, and (iv) the radio access network database is configured to store at least user device context data for one or more user devices associated with the one or more radio access network nodes associated with the radio access network database. The method further includes determining whether the radio access network set identifier received in the connection request corresponds to an associated radio access network set identifier. The method further includes, in an instance in which the radio access network set identifier received in the connection request corresponds to the associated radio access network set identifier, retrieving radio access network database data from the radio access network database associated with the radio access network set identifier, wherein the radio access network database data comprises at least user device context data for the associated user device.

In some embodiments, the user device context data for each of the one or more user devices comprises one or more access stratum security keys or in general, security contexts associated with the user device. In some embodiments, the method further includes providing, to the user device, a response to the connection request, wherein the response to the connection request is secured based at least in part on the one or more access stratum security keys associated with the user device.

In some embodiments, the method further includes determining the radio access network database data for the associated user device based at least in part on at least one of (i) a cell radio network temporary identity, (ii) 5G-S-temporary mobile subscriber identity, (iia) 6G-S-temporary mobile subscriber identity (iii) a next generation application part user device identifier or (iv) any radio access network based user device identifier.

In some embodiments, the method further includes providing, to a central network function, one or more assigned radio access network set identifiers.

In some embodiments, the method further includes storing at least a portion of the radio access network database data in an associated memory.

In some embodiments, the user device context for the user device is retrieved prior to an initial setup context between a radio access network node and an access management function. In some embodiments, the radio access network database further comprises data from an associated core network. In some embodiments, the radio access network set identifier is associated with a hierarchy of one or more other radio access network set identifiers. In some embodiments, one radio network database obtains user device context data from another radio network database using the radio network set identifier or radio network database identifier to determine the other radio network database. In some embodiments, a radio access network node authenticates and authorizes itself prior to obtaining data from a radio network database in a secure manner. In some embodiments, the radio access network database is further configured to store data of pertaining to neighboring radio access network nodes related to a given radio access network node.

In an example embodiment, an apparatus is provided including at least one processor and at least one memory including computer program code with the at least one memory and the computer program code configured to, with the at least one processor, cause the apparatus at least to receive, from a user device, a connection request, wherein (i) the connection request comprises at least a radio network set identifier that is indicative of at least a radio network set or a radio network database, (ii) the radio access network set identifier is indicative of a radio access network database with which a radio access network node previously connected with the user device is associated, (iii) the radio access network database is associated with one or more radio access network nodes, and (iv) the radio access network database is configured to store at least user device context data for one or more user devices associated with the one or more radio access network nodes associated with the radio access network database. The at least one memory and the computer program are further configured to, with the at least one processor, cause the apparatus to determine whether the radio access network set identifier received in the connection request corresponds to an associated radio access network set identifier. The at least one memory and the computer program are further configured to, with the at least one processor, cause the apparatus to, in an instance in which the radio access network set identifier received in the connection request corresponds to the associated radio access network set identifier, retrieve radio access network database data from the radio access network database associated with the radio access network set identifier, wherein the radio access network database data comprises at least user device context data for the associated user device.

In some embodiments, the user device context data for each of the one or more user devices comprises one or more access stratum security keys or in general, security contexts associated with the user device. In some embodiments, the at least one memory and the computer program are further configured to, with the at least one processor, cause the apparatus to provide, to the user device, a response to the connection request, wherein the response to the connection request is secured based at least in part on the one or more access stratum security keys associated with the user device.

In some embodiments, the at least one memory and the computer program are further configured to, with the at least one processor, cause the apparatus to determine the radio access network database data for the associated user device based at least in part on at least one of (i) a cell radio network temporary identity, (ii) 5G-S-temporary mobile subscriber identity, (iia) 6G-S-temporary mobile subscriber identity (iii) a next generation application part user device identifier or (iv) any radio access network based user device identifier.

In some embodiments, the at least one memory and the computer program are further configured to, with the at least one processor, cause the apparatus to provide, to a central network function, one or more assigned radio access network set identifiers.

In some embodiments, the at least one memory and the computer program are further configured to, with the at least one processor, cause the apparatus to store at least a portion of the radio access network database data in an associated memory.

In some embodiments, the user device context for the user device is retrieved prior to an initial setup context between a radio access network node and an access management function. In some embodiments, the radio access network database further comprises data from an associated core network. In some embodiments, the radio access network set identifier is associated with a hierarchy of one or more other radio access network set identifiers. In some embodiments, one radio network database obtains user device context data from another radio network database using the radio network set identifier or radio network database identifier to determine the other radio network database. In some embodiments, a radio access network node authenticates and authorizes itself prior to obtaining data from a radio network database in a secure manner. In some embodiments, the radio access network database is further configured to store data of pertaining to neighboring radio access network nodes related to a given radio access network node.

In an example embodiment, a computer program product is provided that includes at least one non-transitory computer-readable storage medium having computer executable program code instructions stored therein with the computer executable program code instructions including program code instructions configured, upon execution, to receive, from a user device, a connection request, wherein (i) the connection request comprises at least a radio network set identifier that is indicative of at least a radio network set or a radio network database, (ii) the radio access network set identifier is indicative of a radio access network database with which a radio access network node previously connected with the user device is associated, (iii) the radio access network database is associated with one or more radio access network nodes, and (iv) the radio access network database is configured to store at least user device context data for one or more user devices associated with the one or more radio access network nodes associated with the radio access network database. The computer executable program code instructions include program code instructions further configured, upon execution, to determine whether the radio access network set identifier received in the connection request corresponds to an associated radio access network set identifier computer executable program code instructions include program code instructions further configured, upon execution, to in an instance in which the radio access network set identifier received in the connection request corresponds to the associated radio access network set identifier, retrieve radio access network database data from the radio access network database associated with the radio access network set identifier, wherein the radio access network database data comprises at least user device context data for the associated user device.

In some embodiments, the user device context data for each of the one or more user devices comprises one or more access stratum security keys or in general, security contexts associated with the user device. In some embodiments, the computer executable program code instructions include program code instructions further configured, upon execution, to provide, to the user device, a response to the connection request, wherein the response to the connection request is secured based at least in part on the one or more access stratum security keys associated with the user device.

In some embodiments, the computer executable program code instructions include program code instructions further configured, upon execution, to determine the radio access network database data for the associated user device based at least in part on at least one of (i) a cell radio network temporary identity, (ii) 5G-S-temporary mobile subscriber identity, (iia) 6G-S-temporary mobile subscriber identity (iii) a next generation application part user device identifier or (iv) any radio access network based user device identifier.

In some embodiments, the computer executable program code instructions include program code instructions further configured, upon execution, to provide, to a central network function, one or more assigned radio access network set identifiers.

In some embodiments, the computer executable program code instructions include program code instructions further configured, upon execution, to store at least a portion of the radio access network database data in an associated memory.

In some embodiments, the user device context for the user device is retrieved prior to an initial setup context between a radio access network node and an access management function. In some embodiments, the radio access network database further comprises data from an associated core network. In some embodiments, the radio access network set identifier is associated with a hierarchy of one or more other radio access network set identifiers. In some embodiments, one radio network database obtains user device context data from another radio network database using the radio network set identifier or radio network database identifier to determine the other radio network database. In some embodiments, a radio access network node authenticates and authorizes itself prior to obtaining data from a radio network database in a secure manner. In some embodiments, the radio access network database is further configured to store data of pertaining to neighboring radio access network nodes related to a given radio access network node.

In a further example embodiment, an apparatus is provided that includes means for receiving, from a user device, a connection request, wherein (i) the connection request comprises at least a radio network set identifier that is indicative of at least a radio network set or a radio network database, (ii) the radio access network set identifier is indicative of a radio access network database with which a radio access network node previously connected with the user device is associated, (iii) the radio access network database is associated with one or more radio access network nodes, and (iv) the radio access network database is configured to store at least user device context data for one or more user devices associated with the one or more radio access network nodes associated with the radio access network database. The apparatus also includes means for determining whether the radio access network set identifier received in the connection request corresponds to an associated radio access network set identifier. The apparatus also includes means for, in an instance in which the radio access network set identifier received in the connection request corresponds to the associated radio access network set identifier, retrieving radio access network database data from the radio access network database associated with the radio access network set identifier, wherein the radio access network database data comprises at least user device context data for the associated user device.

In some embodiments, the user device context data for each of the one or more user devices comprises one or more access stratum security keys or in general, security contexts associated with the user device. In some embodiments, the apparatus also includes means for providing, to the user device, a response to the connection request, wherein the response to the connection request is secured based at least in part on the one or more access stratum security keys associated with the user device.

In some embodiments, the apparatus also includes means determining the radio access network database data for the associated user device based at least in part on at least one of (i) a cell radio network temporary identity, (ii) 5G-S-temporary mobile subscriber identity, (iia) 6G-S-temporary mobile subscriber identity (iii) a next generation application part user device identifier or (iv) any radio access network based user device identifier.

In some embodiments, the apparatus also includes means providing, to a central network function, one or more assigned radio access network set identifiers.

In some embodiments, the apparatus also includes means storing at least a portion of the radio access network database data in an associated memory.

In some embodiments, the user device context for the user device is retrieved prior to an initial setup context between a radio access network node and an access management function. In some embodiments, the radio access network database further comprises data from an associated core network. In some embodiments, the radio access network set identifier is associated with a hierarchy of one or more other radio access network set identifiers. In some embodiments, one radio network database obtains user device context data from another radio network database using the radio network set identifier or radio network database identifier to determine the other radio network database. In some embodiments, a radio access network node authenticates and authorizes itself prior to obtaining data from a radio network database in a secure manner. In some embodiments, the radio access network database is further configured to store data of pertaining to neighboring radio access network nodes related to a given radio access network node.

In an example embodiment, a method is provided that includes receiving, from a radio access network node, a radio access network set identifier. The method further includes storing the radio access network set identifier. The method further includes providing a connection request to a radio access network node, wherein (i) the connection request comprises at least a radio access network set identifier or radio access network database identifier, (ii) the radio access network set identifier is indicative of a radio access network database with which a radio access network node previously connected with the apparatus is associated, (iii) the radio access network database is associated with one or more radio access network nodes, and (iv) the radio access network database is configured to store at least user device context data for one or more user devices associated with the one or more radio access network nodes associated with the radio access network database.

In some embodiments, the method further includes receiving, from the radio access network node, a connection release signal. The connection release signal redirects the connection to a different frequency, cell, radio access network node, and the connection release signal is encrypted based at least in part using stored associated access stratum security keys.

In some embodiments, the connection request is provided to a second radio access network node, different than the radio access network node from which the radio access network set identifier was received. In some embodiments, the connection request further comprises a 5G-S-temporary mobile subscription identifier or 6G-S-temporary mobile subscription identifier. In some embodiments, the received radio access network set identifier is indicative of a radio access network database with which a radio access network node previously connected and with the user device is associated. In some embodiments, the connection request further comprises at least a user device identifier, the user device identifier serves as unique key for the radio access network node to retrieve user device context data from the radio access network database.

In an example embodiment, an apparatus is provided including at least one processor and at least one memory including computer program code with the at least one memory and the computer program code configured to, with the at least one processor, cause the apparatus at least to receive, from a radio access network node, a radio access network set identifier. The at least one memory and the computer program code further configured to, with the at least one processor, cause the apparatus to store the radio access network set identifier. The at least one memory and the computer program code further configured to, with the at least one processor, cause the apparatus to provide a connection request to a radio access network node, wherein (i) the connection request comprises at least a radio access network set identifier or radio access network database identifier, (ii) the radio access network set identifier is indicative of a radio access network database with which a radio access network node previously connected with the apparatus is associated, (iii) the radio access network database is associated with one or more radio access network nodes, and (iv) the radio access network database is configured to store at least user device context data for one or more user devices associated with the one or more radio access network nodes associated with the radio access network database.

In some embodiments, the at least one memory and the computer program code further configured to, with the at least one processor, cause the apparatus to receive, from the radio access network node, a connection release signal. The connection release signal redirects the connection to a different frequency, cell, radio access network node, and the connection release signal is encrypted based at least in part using stored associated access stratum security keys.

In some embodiments, the connection request is provided to a second radio access network node, different than the radio access network node from which the radio access network set identifier was received. In some embodiments, the connection request further comprises a 5G-S-temporary mobile subscription identifier or 6G-S-temporary mobile subscription identifier. In some embodiments, the received radio access network set identifier is indicative of a radio access network database with which a radio access network node previously connected and with the user device is associated. In some embodiments, the connection request further comprises at least a user device identifier, the user device identifier serves as unique key for the radio access network node to retrieve user device context data from the radio access network database.

In an example embodiment, a computer program product is provided that includes the at least one non-transitory computer-readable storage medium having the computer executable program code instructions stored therein with the computer executable program code instructions including program code instructions configured, upon execution, to receive, from a radio access network node, a radio access network set identifier. The computer executable program code instructions include program code instructions further configured, upon execution, to store the radio access network set identifier. The computer executable program code instructions include program code instructions further configured, upon execution, to provide a connection request to a radio access network node, wherein (i) the connection request comprises at least a radio access network set identifier or radio access network database identifier, (ii) the radio access network set identifier is indicative of a radio access network database with which a radio access network node previously connected with the apparatus is associated, (iii) the radio access network database is associated with one or more radio access network nodes, and (iv) the radio access network database is configured to store at least user device context data for one or more user devices associated with the one or more radio access network nodes associated with the radio access network database.

In some embodiments, the computer executable program code instructions include program code instructions further configured, upon execution, to receive, from the radio access network node, a connection release signal. The connection release signal redirects the connection to a different frequency, cell, radio access network node, and the connection release signal is encrypted based at least in part using stored associated access stratum security keys.

In some embodiments, the connection request is provided to a second radio access network node, different than the radio access network node from which the radio access network set identifier was received. In some embodiments, the connection request further comprises a 5G-S-temporary mobile subscription identifier or 6G-S-temporary mobile subscription identifier. In some embodiments, the received radio access network set identifier is indicative of a radio access network database with which a radio access network node previously connected and with the user device is associated. In some embodiments, the connection request further comprises at least a user device identifier, the user device identifier serves as unique key for the radio access network node to retrieve user device context data from the radio access network database.

In an example embodiment, an apparatus is provided that includes means for receiving, from a radio access network node, a radio access network set identifier. The apparatus also includes means for storing the radio access network set identifier. The apparatus also includes means for providing a connection request to a radio access network node, wherein (i) the connection request comprises at least a radio access network set identifier or radio access network database identifier, (ii) the radio access network set identifier is indicative of a radio access network database with which a radio access network node previously connected with the apparatus is associated, (iii) the radio access network database is associated with one or more radio access network nodes, and (iv) the radio access network database is configured to store at least user device context data for one or more user devices associated with the one or more radio access network nodes associated with the radio access network database.

In some embodiments, the apparatus also includes means for receiving, from the radio access network node, a connection release signal. The connection release signal redirects the connection to a different frequency, cell, radio access network node, and the connection release signal is encrypted based at least in part using stored associated access stratum security keys.

In some embodiments, the connection request is provided to a second radio access network node, different than the radio access network node from which the radio access network set identifier was received. In some embodiments, the connection request further comprises a 5G-S-temporary mobile subscription identifier or 6G-S-temporary mobile subscription identifier. In some embodiments, the received radio access network set identifier is indicative of a radio access network database with which a radio access network node previously connected and with the user device is associated. In some embodiments, the connection request further comprises at least a user device identifier, the user device identifier serves as unique key for the radio access network node to retrieve user device context data from the radio access network database.

In an example embodiment, a method is provided that includes receiving, from a radio access network node, a request for access to at least a portion of radio access network database data. In some embodiments, the request for access comprises at least a radio access network set identifier associated with the radio access network node. The method further includes providing the radio access network node with at least a portion of the radio access network database data including user device context data for one or more user devices associated with the radio access network node.

In some embodiments, the method further includes authenticating and authorizing the radio access network node associated with the request for radio access network database data based at least in part on a radio access network set identifier associated with the radio access network node. In some embodiments, the method further includes establishing a secure connection with the radio access network node. In some embodiments, the method further includes providing the radio access network node with at least a portion of the radio access network database data including user device context data for one or more user devices associated with the radio access network node in an instance the radio access network node is authenticated and authorized.

In some embodiments, the method further includes receiving one or more instances of core network data from a core network function. In some embodiments, the method further includes storing the one or more instances of core network data in an associated memory.

In some embodiments, the method further includes receiving, from one or more associated radio access networks, user device update data. In some embodiments, the method further includes updating the stored radio access network database data based at least in part on the received user device update data. In some embodiments, the method further includes determining one or more associated radio access network nodes to provide with updated radio access network database data. In some embodiments, the method includes providing at least a portion of the radio access network database data to the one or more determined associated radio access network nodes.

In some embodiments, at least a portion of the radio access network database data is associated with one or more radio access network nodes such that the one or more radio access network nodes are authorized to access the portion of the radio access network database data. In some embodiments, the one or more associated radio access network nodes authorized to access at least a portion of the radio access network database data is based at least in part on a geographic location of each of the one or more radio access network nodes.

In an example embodiment, an apparatus is provided including at least one processor and at least one memory including computer program code with the at least one memory and the computer program code configured to, with the at least one processor, cause the apparatus at least receive, from a radio access network node, a request for access to at least a portion of radio access network database data. In some embodiments, the request for access comprises at least a radio access network set identifier associated with the radio access network node. In some embodiments, the at least one memory and the computer program code further configured to, with the at least one processor, cause the apparatus to provide the radio access network node with at least a portion of the radio access network database data including user device context data for one or more user devices associated with the radio access network node.

In some embodiments, the at least one memory and the computer program code further configured to, with the at least one processor, cause the apparatus to authenticate and authorize the radio access network node associated with the request for radio access network database data based at least in part on a radio access network set identifier associated with the radio access network node. In some embodiments, the at least one memory and the computer program code further configured to, with the at least one processor, cause the apparatus to establish a secure connection with the radio access network node. In some embodiments, the at least one memory and the computer program code further configured to, with the at least one processor, cause the apparatus to provide the radio access network node with at least a portion of the radio access network database data including user device context data for one or more user devices associated with the radio access network node in an instance the radio access network node is authenticated and authorized.

In some embodiments, the at least one memory and the computer program code further configured to, with the at least one processor, cause the apparatus to receive one or more instances of core network data from a core network function. In some embodiments, the at least one memory and the computer program code further configured to, with the at least one processor, cause the apparatus to store the one or more instances of core network data in an associated memory.

In some embodiments, the at least one memory and the computer program code further configured to, with the at least one processor, cause the apparatus to receive, from one or more associated radio access networks, user device update data. In some embodiments, the at least one memory and the computer program code further configured to, with the at least one processor, cause the apparatus to update the stored radio access network database data based at least in part on the received user device update data. In some embodiments, the at least one memory and the computer program code further configured to, with the at least one processor, cause the apparatus to determine one or more associated radio access network nodes to provide with updated radio access network database data. In some embodiments, the at least one memory and the computer program code further configured to, with the at least one processor, cause the apparatus to provide at least a portion of the radio access network database data to the one or more determined associated radio access network nodes.

In some embodiments, at least a portion of the radio access network database data is associated with one or more radio access network nodes such that the one or more radio access network nodes are authorized to access the portion of the radio access network database data. In some embodiments, the one or more associated radio access network nodes authorized to access at least a portion of the radio access network database data is based at least in part on a geographic location of each of the one or more radio access network nodes.

In an example embodiment, a computer program product is provided that includes the at least one non-transitory computer-readable storage medium having the computer executable program code instructions stored therein with the computer executable program code instructions including program code instructions configured, upon execution, to receive, from a radio access network node, a request for access to at least a portion of radio access network database data. In some embodiments, the request for access comprises at least a radio access network set identifier associated with the radio access network node. In some embodiments, the at least one memory and the computer program code are further configured to provide the radio access network node with at least a portion of the radio access network database data including user device context data for one or more user devices associated with the radio access network node.

In some embodiments, the at least one memory and the computer program code are further configured to authenticate and authorize the radio access network node associated with the request for radio access network database data based at least in part on a radio access network set identifier associated with the radio access network node. In some embodiments, the at least one memory and the computer program code are further configured to establish a secure connection with the radio access network node. In some embodiments, the at least one memory and the computer program code are further configured to provide the radio access network node with at least a portion of the radio access network database data including user device context data for one or more user devices associated with the radio access network node in an instance the radio access network node is authenticated and authorized.

In some embodiments, the at least one memory and the computer program code are further configured to receive one or more instances of core network data from a core network function. In some embodiments, the at least one memory and the computer program code are further configured to store the one or more instances of core network data in an associated memory.

In some embodiments, the at least one memory and the computer program code are further configured to receive, from one or more associated radio access networks, user device update data. In some embodiments, the at least one memory and the computer program code are further configured to update the stored radio access network database data based at least in part on the received user device update data. In some embodiments, the at least one memory and the computer program code are further configured to determine one or more associated radio access network nodes to provide with updated radio access network database data. In some embodiments, the at least one memory and the computer program code are further configured to provide at least a portion of the radio access network database data to the one or more determined associated radio access network nodes.

In some embodiments, at least a portion of the radio access network database data is associated with one or more radio access network nodes such that the one or more radio access network nodes are authorized to access the portion of the radio access network database data. In some embodiments, the one or more associated radio access network nodes authorized to access at least a portion of the radio access network database data is based at least in part on a geographic location of each of the one or more radio access network nodes.

In an example embodiment an apparatus is provided that includes means for receiving, from a radio access network node, a request for access to at least a portion of radio access network database data. In some embodiments, the request for access comprises at least a radio access network set identifier associated with the radio access network node. The apparatus further includes means for providing the radio access network node with at least a portion of the radio access network database data including user device context data for one or more user devices associated with the radio access network node.

In some embodiments, the apparatus further includes means for authenticating and authorizing the radio access network node associated with the request for radio access network database data based at least in part on a radio access network set identifier associated with the radio access network node. In some embodiments, the apparatus also includes means for establishing a secure connection with the radio access network node. In some embodiments, the apparatus also includes means for providing the radio access network node with at least a portion of the radio access network database data including user device context data for one or more user devices associated with the radio access network node in an instance the radio access network node is authenticated and authorized.

In some embodiments, the apparatus further includes means for receiving one or more instances of core network data from a core network function. In some embodiments, the apparatus further includes means for storing the one or more instances of core network data in an associated memory.

In some embodiments, the apparatus further includes means for receiving, from one or more associated radio access networks, user device update data. In some embodiments, the apparatus further includes means for updating the stored radio access network database data based at least in part on the received user device update data. In some embodiments, the apparatus further includes means for determining one or more associated radio access network nodes to provide with updated radio access network database data. In some embodiments, the apparatus further includes means for providing at least a portion of the radio access network database data to the one or more determined associated radio access network nodes.

In some embodiments, at least a portion of the radio access network database data is associated with one or more radio access network nodes such that the one or more radio access network nodes are authorized to access the portion of the radio access network database data. In some embodiments, the one or more associated radio access network nodes authorized to access at least a portion of the radio access network database data is based at least in part on a geographic location of each of the one or more radio access network nodes.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 shows radio access network nodes and radio access network databases in a communication system in an illustrative embodiment;

FIG. 2 shows a communication system in an illustrative embodiment;

FIG. 3 is a block diagram of an apparatus that may be specifically configured in accordance with an example embodiment of the present disclosure;

FIGS. 4A-B show message flows for connection request message procedures in an illustrative embodiment;

FIG. 5 illustrates a flow diagram for retrieving radio access network database data from a radio access network database in an illustrative embodiment;

FIG. 6 illustrates a flow diagram for providing a connection request in an illustrative embodiment;

FIG. 7 illustrates a flow diagram for providing a radio access network node with at least a portion of radio access network database data in an illustrative embodiment;

FIG. 8 illustrates a flow diagram for storing one or more instances of core network data in an illustrative embodiment; and

FIG. 9 illustrates a flow diagram for updating radio access network database data in an illustrative embodiment.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

The evolution of new communication technologies such as 5G and 6G have improved upon existing technologies such as 2G, 3G, 4G, LTE and has thus resulted in improved network connectivity. These next generation technologies encompass next generation radio technology which allow for higher frequencies signals. The use of higher frequency signals allows for increased signal bandwidth such that more data can be transmitted in such signals. However, higher frequencies tend to dissipate more quickly and further, are more likely to be absorbed by environmental factors, such as water vapor. Already, 5G frequency bands anticipate frequencies beyond 100 gigahertz (GHz) and even frequencies expanding into the terahertz range are considered. As such, the cell size and inter-site distance (ISD) associated with radio access network (RAN) nodes has decreased. Due to the decreased cell sizes and ISD of RAN nodes, user devices (UEs) that move through the cells associated with one or more RAN nodes may enter and exit cells more frequently, resulting in an increase in network signaling.

Currently, a RAN node, such as a next generation node B (gNB), communicates with a core network function, such as an access and mobility management function (AMF), to obtain UE context information during an initial context setup and then obtains UE capabilities using radio resource control (RRC) signaling with the UE. As such, the UE context may not be available to a RAN node until after an initial context setup is performed with an associated AMF. Given the increased frequency of signaling due to the smaller cell sizes and ISD between RAN nodes, this may result in an overall increase in signaling in the network due to more frequent UE traversals through areas associated with different RAN nodes. Furthermore, when a UE moves from a connected state to an idle state, the AMF may still send an initial context setup prior to the RAN node retrieving UE context, even if the UE attempts to connect to the same RAN node to which the UE was previously connected.

Therefore, it may be beneficial to improve resiliency support in the RAN regardless of the status of a UE (e.g., connected, idle, inactive, etc.) and/or prior to the initial context setup by the AMF. This would reduce the overall network signaling, leading to improved resiliency, security, reduced network latency and improved network speeds. As such, a radio access network database (RAN DB) configured to store UE context information for one or more RAN nodes may allow the one or more associated RAN nodes to obtain UE context information. Only authenticated and authorized RAN nodes are able to access the RAN DB in a secure manner. This may reduce the need for network signaling between a RAN node and a UE, a RAN node and an AMF, and between RAN nodes. Furthermore, by obtaining UE context prior to an initial context setup, a RAN node may obtain one or more access stratum (AS) security keys and security contexts such that the RAN node may encrypt messages to the UE earlier in the communication process, leading to enhanced security for messages between the RAN node and a UE. The RAN DB may also store information about neighbor cells or neighbor RAN nodes of a particular given RAN node.

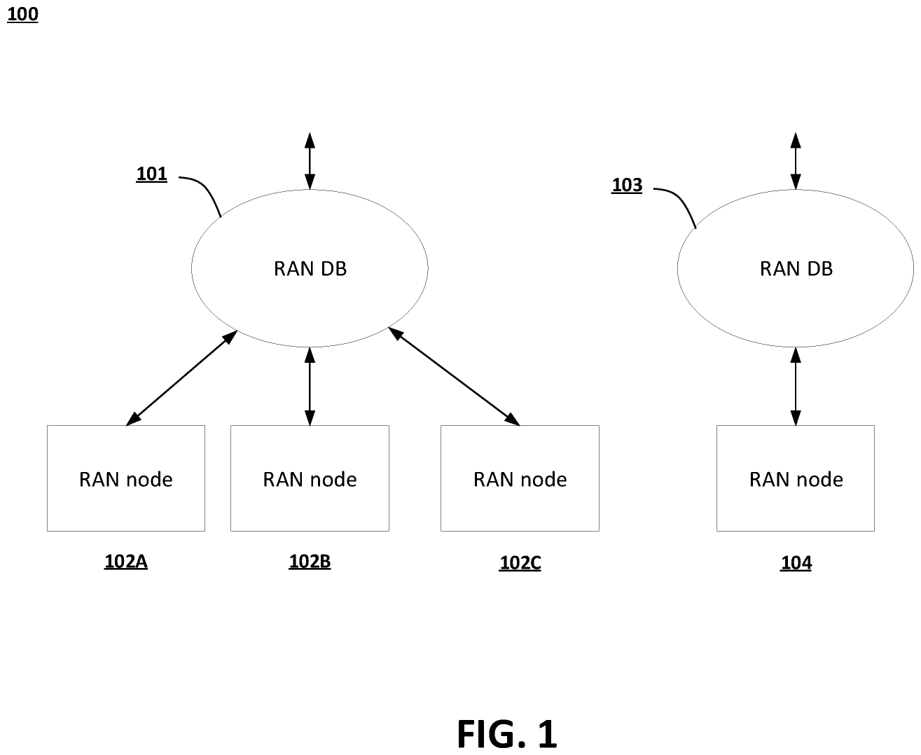

FIG. 1 illustrates an example communication network 100 within which illustrative embodiments are to be implemented. However, it is to be appreciated that embodiments are not limited to the network configurations illustrated herein or otherwise described below. It is to be understood that the elements shown in communication system 100 are intended to represent an example embodiment of a RAN DB connected to one or more RAN nodes, but any number of RAN nodes may be contemplated.

In the communication network 100 depicted in FIG. 1, three RAN nodes 102A-102C are connected to the same RAN DB 101 and RAN node 104 is connected to a different RAN DB 103. Each RAN node 102A-C and 104 may be located in a particular geographic location. Further, each RAN node 102A-C and 104 may be associated with a particular cell size and ISD which correspond to a geographic region within which the RAN node is able to receive UE connection requests and/or other communication signals. In some embodiments, a portion of these geographic regions may overlap for one or more RAN nodes.

A RAN DB 101 and 103 may be configured to store RAN DB data. In some embodiments, the RAN DB data includes at least UE context data for one or more UEs which are or were previously connected to an associated RAN node. For example, the RAN DB 101 may store UE context data for each UE currently or previously connected to RAN node 102A. In some embodiments, each RAN DB 101 and 103 may be configured to receive one or more instances of core network data from a core network function, such as an AMF, and store the one or more instances of core network data in an associated memory as RAN DB data.

Each RAN node may be associated with a RAN DB. In the communication network 100 depicted in FIG. 1, for example, RAN nodes 102A-102C are associated with RAN DB 101 and RAN node 104 is associated with RAN DB 103. Each RAN node may be assigned a radio access network set identifier (RAN SET ID). The value of the RAN SET ID may be indicative of the RAN DB with which a RAN node is associated. The RAN node may use this value for the RAN SET ID to determine which RAN DB to access for RAN DB data. Each RAN node associated with a particular RAN DB may access at least a portion of the RAN DB data. For example, the RAN nodes 102A-C may share a RAN SET ID value as they are each associated with RAN DB 101. The RAN SET ID value for the RAN node 104 may be different than the RAN SET ID value for RAN nodes 102A-C as RAN node 104 is associated with RAN DB 103. The RAN node may assign a UE identifier or may reuse existing identifiers as a unique key for storing UE context data in the RAN DB. The UE will provide the UE identifier along with the RAN SET ID such that the RAN node can locate the appropriate RAN DB, as well as the address where the UE's context is stored within the RAN DB.

In some embodiments, a RAN SET ID corresponding to a particular RAN DB may be associated with a hierarchy of one or more other RAN SET IDs. A higher hierarchical level RAN SET ID may include two or more lower hierarchical level RAN SET IDs such that the RAN DB associated with the higher hierarchical level RAN SET ID includes RAN DB data from each respective RAN DB associated with the two or more lower hierarchical level RAN SET IDs. As such, the RAN SET ID for a given RAN DB may determine the amount of RAN DB data accessible to the particular RAN node. For example, a RAN node associated with a higher hierarchical level RAN SET ID may have access to RAN DB data of more UEs than an RAN node associated with a lower hierarchical level RAN SET ID.

In an instance a UE is connected with RAN node 102A, the UE context data may be stored in RAN DB 101. As such, the UE context data may be accessible to RAN node 102B and 102C because these RAN nodes are also associated with RAN DB 101. In an instance a UE moves out of the cell associated with RAN node 102A and into a cell associated with RAN node 102B, RAN node 102B may retrieve the UE context for the UE from RAN DB 101 without an initial context setup with the associated core network function, such as the AMF. As such, an associated core network function need not provide UE context data to the RAN node during an initial context setup, thereby reducing the size of the exchanged messages and thus reducing overall network bandwidth usage. Furthermore, the storing of UE context data allows for a reduction in signaling of UE context data between RAN nodes, thus again reducing overall network bandwidth usage.

Additionally, in an instance a UE switches from a connected state with a RAN node to an idle state and then attempts to enter a connected state with the same RAN node, the RAN node may not need to obtain UE capability information from the UE as this is provided by the UE context information stored in the associated RAN DB. As such, the size of the RRC messages between the UE and gNB may be reduced as the UE need not provide its capabilities to the RAN node again but rather, just the unique UE identifier.

If the UE previously associated with RAN Node 102A moves into a cell associated with RAN node 104, RAN node 104 may not be able to retrieve the UE context data as the RAN node 104 is not associated with the RAN DB 101. In such a case, the RAN node 104 may attempt to obtain UE context data via X2/Xn signaling from another RAN node, such as RAN nodes 102A-C and/or obtain UE context data from a core network function, such as the AMF and/or obtain UE context data from the RAN DB hierarchy, i.e. RAN node 104 contacts RAN DB 103 and RAN DB 103 obtains data from RAN DB 101 directly or from a higher level RAN DB. It is also possible that one RAN DB obtains data from another RAN DB directly and provides these data to an associated RAN node.

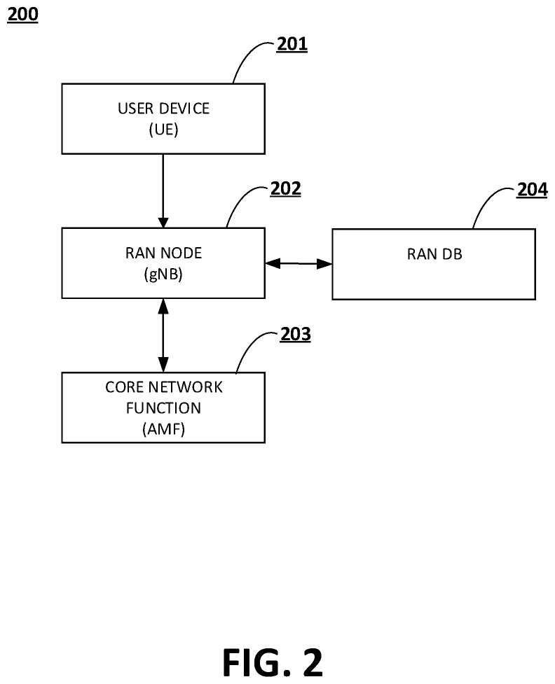

FIG. 2 shows a communication system 200 within which certain illustrative embodiments are to be implemented. However, it is to be appreciated that embodiments are not limited to the network configurations illustrated herein or otherwise described below. It is to be understood that the elements shown in communication system 200 are intended to represent a primary function provided within the system. As such, the blocks shown in FIG. 2 reference specific elements in 5G networks that provide the primary functions. However, other network elements may be used to implement some or all of the primary functions represented. Also, it is to be understood that not all functions of a 5G network are depicted in FIG. 2. Rather, functions that facilitate an explanation of illustrative embodiments are represented.

By way of example, the communication system 200 may be deployed within a radio access architecture. However, the system may be deployed in other applications including within other communication networks including, for example, long term evolution advanced (LTE Advanced, LTE-A), a universal mobile telecommunications system (UMTS) radio access network (UTRAN or E-UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof. Any access network eligible to access the 5G core network such as an Un-trusted Non 3GPP access terminated at a Non-3GPP interworking function (N3IWF), a trusted Non-3GPP access terminated at a trusted non-3GPP gateway function (TNGF) or a Wireline access terminated at a wireless access gateway function (W-AGF) may be used instead of the NG RAN/gNB. Moreover, although described herein in conjunction with a 5G core network, the method, apparatus and computer program product of certain example embodiments may be employed in conjunction with other technologies, such as a 6G network or the like.

In the radio access architecture of FIG. 2, user device 201 is configured to be in a wireless connection on one or more communication channels in a cell with a radio access network (RAN) node, such as a gNB. The physical link from a user equipment 201 to a gNB is called the uplink or reverse link and the physical link from the gNB to the UE is called the downlink or forward link. It should be appreciated that the gNBs, or their functionalities may be implemented by using any node, host, server or access point (AP), etc. entity suitable for such a usage.

A communications system typically comprises more than one gNB, in which case the gNBs may also be configured to communicate with one another over links, wired or wireless, designed for the purpose. These links may be used for signaling purposes. The gNB is a computing device configured to control the radio resources of the communication system to which the gNB is coupled. The gNB may also be referred to as a base station, an access point or any other type of interfacing device including a relay station capable of operating in a wireless environment. The gNB includes or is coupled to transceiver(s). From the transceivers of the gNB, a connection is provided to an antenna unit that establishes bi-directional radio links to UEs. As such, the transceivers of the gNB and the transceivers of the UEs may include transmitters and receivers configured to communicate via a channel. Although reference is made to a gNB herein, although this is by way of example, but not of limitation, as other types of RAN nodes may alternatively be employed.

Accordingly, as shown, communication system 200 comprises UE 201 that communicates, such as via an air interface, with a RAN node 202. The UE 201 may be a mobile station, and such a mobile station may comprise, by way of example, a mobile telephone, a computer, or any other type of communication device. In an LTE-V2X implementation, one or more UEs may deployed in a given vehicle. The term “user device” or “user equipment” as used herein is therefore intended to be construed broadly, so as to encompass a variety of different types of mobile stations, subscriber stations or, more generally, communication devices, including examples such as a combination of a data card inserted in a laptop or other equipment (e.g., a vehicle). The user device 201 may also refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a UE may also be a nearly exclusive uplink only device, of which an example is a camera or video camera loading images or video clips to a network. A UE may also be a device having the capability to operate in an IoT network, which is a scenario in which objects are provided with the ability to transfer data over a network without requiring human-to-human or human-to-computer interaction. The user device (or in some embodiments a layer 3 relay node) is configured to perform one or more user device functionalities. The user device may also be called a subscriber unit, mobile station, remote terminal, access terminal, user terminal or user equipment just to mention but a few names or apparatuses.

In one embodiment, UE 201 is comprised of a Universal Integrated Circuit Card (UICC) and Mobile Equipment (ME). The UICC is the user-dependent part of the UE and contains at least one Universal Subscriber Identity Module (USIM) and appropriate application software. The USIM securely stores the International Mobile Subscriber Identity (IMSI) number and its related key, which are used to identify and authenticate subscribers to access networks. The ME is the user-independent part of the UE and contains terminal equipment (TE) functions and various mobile termination (MT) functions.

The RAN node 202 is illustratively part of a RAN of the communication system 200. In a 5GS network, the RAN node is typically implemented by an gNB. Such an access network may comprise, for example, a plurality of base stations which may include one or more gNB (which may also be split in a centralized unit (CU) and a distributed unit (DU) part) and/or other RAN node types, such as evolved node Bs (eNBs), node Bs, base stations (BTS) and/or non-3GPP interworking function (N3IWF), or any other types of access nodes such as WLAN access points, as well as one or more associated radio network control functions. The base stations and radio network control functions may be logically separate entities, but in a given embodiment may be implemented in the same physical network element, such as, for example, a base station router or femto cellular access point. As will be appreciated by one of skill in the art, any variety of RAN nodes and/or access nodes may also implement similar operations, functions, etc.

In some example embodiments, the RAN node 202 is operatively coupled to a core network function 203, such as via an NG interface. In a 5G network, the function is typically implemented by an AMF. A core network function may be an element of function in the core network (CN) part of the communication network 200 that generates, among other network operations, and provides initial UE context to a RAN node in an instance a RAN DB is not utilized.

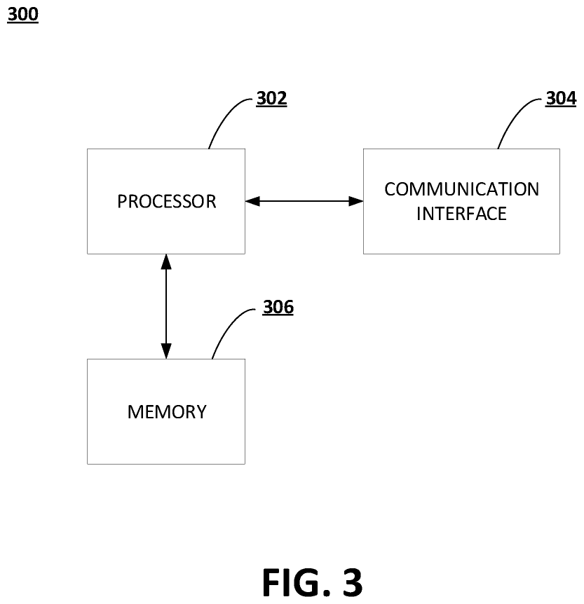

One example of an apparatus 300 that may be configured to function as a network entity, such as a UE, RAN node, and/or RAN DB, is depicted in FIG. 3. As shown in FIG. 3, the apparatus 300 includes, is associated with or is in communication with processing circuitry 302, a memory 306 and a communication interface 304. The processing circuitry 302 may be in communication with the memory device via a bus for passing information among components of the apparatus 300. The memory device 306 may be non-transitory and may include, for example, one or more volatile and/or non-volatile memories. In other words, for example, the memory device 306 may be an electronic storage device (e.g., a computer readable storage medium) comprising gates configured to store data (e.g., bits) that may be retrievable by a machine (e.g., a computing device like the processing circuitry). The memory device 306 may be configured to store information, data, content, applications, instructions, or the like for enabling the apparatus to carry out various functions in accordance with an example embodiment of the present disclosure. For example, the memory device 306 could be configured to buffer input data for processing by the processing circuitry 302. Additionally or alternatively, the memory device 306 could be configured to store instructions for execution by the processing circuitry 302.

In some example embodiments, the RAN node 202 is operatively coupled to a RAN DB 204. In some embodiments, the RAN node 202 and RAN DB 204 may communicate with one another over links, wired or wireless, designed for the purpose. These links may be used for signaling purposes. The RAN node 202 may be associated with RAN SET ID values indicative of one or more RAN DBs to which the RAN node 202 may have access. In some embodiments, the RAN SET ID is associated with a hierarchy of one or more other RAN SET IDs. A higher hierarchical level RAN SET ID may include two or more lower hierarchical level RAN SET IDs such that the RAN DB associated with the higher hierarchical level RAN SET ID includes RAN DB data from each respective RAN DB associated with the two or more lower hierarchical level RAN SET IDs. In some embodiments, the RAN node 202 may provide a RAN SET ID value to a UE during a connection process. The RAN node 202 may be configured to attempt to retrieve RAN DB data from the one or more RAN DB associated with the associated RAN SET ID of the RAN node during a connection procedure with a UE. The RAN node 202 may be configured to store at least a portion of the retrieved RAN DB data in an associated memory such that the retrieved RAN DB data remains locally accessible to the RAN node.

In some embodiments, the RAN DB 204 may be configured to store a list of one or more associated RAN nodes. The one or more associated RAN nodes may be RAN nodes allowed to access at least part of the RAN DB data. In some embodiments, the list of one or more associated RAN nodes further includes one or more RAN node preferences. The one or more RAN node preferences may be indicative of when a RAN node would like to receive updated RAN DB data. For example, RAN node preferences may include, but are not limited to, immediate, periodic, and essential only. An immediate RAN node preference may indicate to the RAN DB 204 to immediately provide the particular RAN node with updated RAN DB data. A periodic RAN node preference may indicate to the RAN DB 204 to periodically provide the particular RAN node with updated RAN DB data.

The RAN DB 204 may be configured to store a RAN DB data, which may include UE context data for each UE connected to a RAN node associated with the RAN DB 204. In some embodiments, the RAN DB 204 may include a UE profile for each UE currently or previously connected to one or more RAN nodes associated with the RAN DB 204. The UE context data for each UE may be stored in the corresponding UE profile such that the RAN DB 204, an associated RAN node, or other associated network entity, may use the UE profile to identify relevant UE context data for each UE. In some embodiments, the UE profile in the RAN DB 204 is identified by a cell radio network temporary identifier (C-RNTI) value, 5G-S-Temporary mobile subscription identity (5G-S-TMSI) value in case of 5G or 6G-S-TMSI in case of 6G, and/or next generation application part identifier (NGAP ID) value associated with a particular UE.

In a 5G network, a core network function is typically implemented by an AMF. A core network function may be an element of function in the core network (CN) part of the communication network 200 that generates and/or provides, among other network operations, initial UE context data to a RAN node in an instance a RAN DB is not utilized.

The apparatus 300 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processing circuitry 302 may be embodied in a number of different ways. For example, the processing circuitry 302 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processing circuitry 302 may be configured to execute instructions stored in the memory device 306 or otherwise accessible to the processing circuitry 302. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processing circuitry 302 is embodied as an executor of instructions, the instructions may specifically configure the processor to perform the algorithms and/or operations described herein when the instructions are executed. However, in some cases, the processing circuitry 302 may be a processor of a specific device (e.g., an image or video processing system) configured to employ an embodiment of the present invention by further configuration of the processing circuitry by instructions for performing the algorithms and/or operations described herein. The processing circuitry 302 may include, among other things, a clock, an arithmetic logic unit (ALU) and logic gates configured to support operation of the processing circuitry.

The communication interface 304 may be any means such as a device or circuitry embodied in either hardware or a combination of hardware and software that is configured to receive and/or transmit data, including media content in the form of video or image files, one or more audio tracks or the like. In this regard, the communication interface 304 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

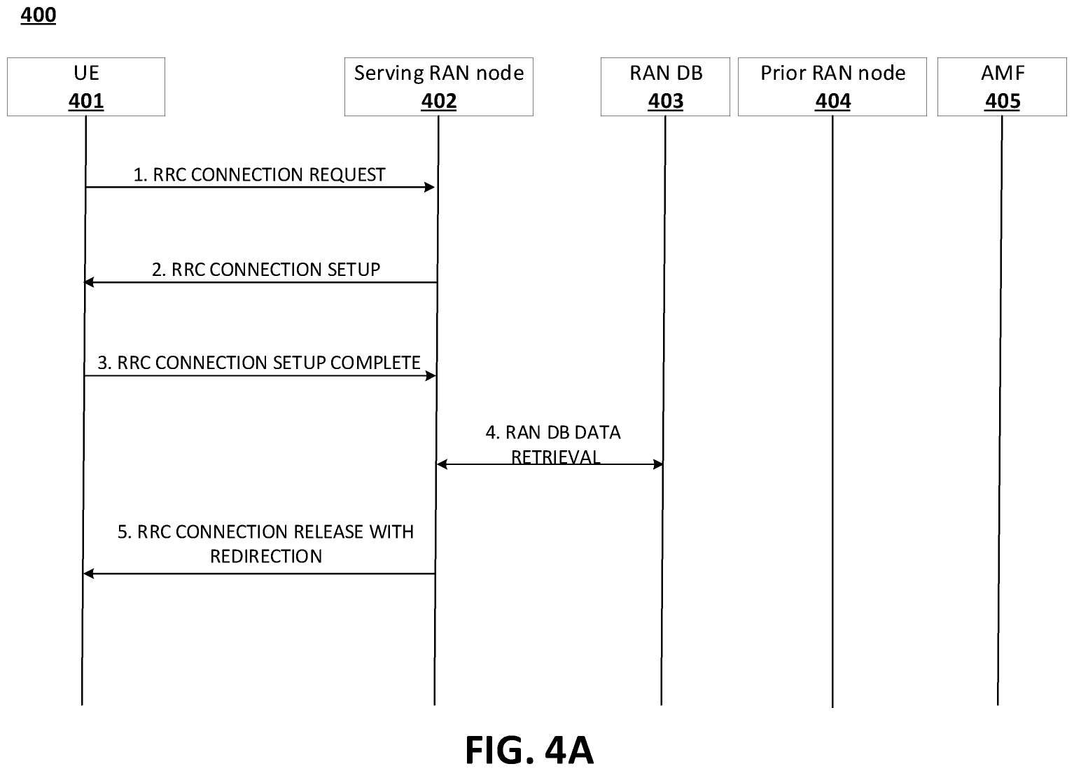

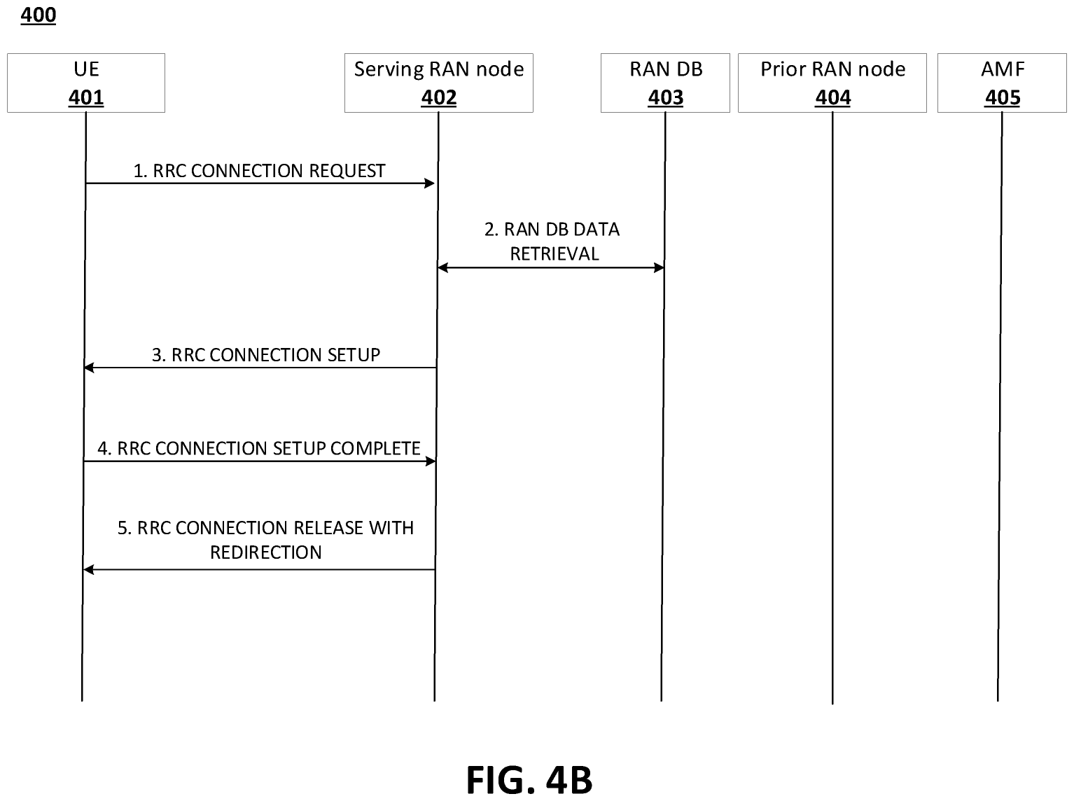

FIGS. 4A-B illustrate connection request messages exchanged between a UE 401 and a serving RAN node 402. In some embodiments, the serving RAN node 402 may be the RAN node with which the UE 401 is currently in communication. Specifically, the connection request messages may be RRC messages wherein the serving RAN node 402 may utilize a RAN DB 403 to obtain UE context data without signaling to an AMF 405 or prior RAN node 404 to which the UE was previously connected.

In operation 1 of FIG. 4A, the UE 401 may transmit a RRC connection request (also called RRC setup request) message to a serving RAN node 402. In some embodiments, the UE may transmit the RRC connection request in response to switching from an idle to a connected state. In some embodiments, the UE may transmit the RRC connection request in response to entering a new cell area associated with a different RAN node. In some embodiments, the serving RAN node 402 is the same RAN node to which the UE was previously connected (e.g., prior RAN node 404). In some embodiments, the serving RAN node 402 is a different RAN node than that to which the UE was previously connected such that serving RAN node 402 and prior RAN node 404 are two different RAN nodes. In some embodiments, prior RAN node 404 and serving RAN node 402 are associated with the same RAN SET ID value corresponding to RAN DB 403.

In some embodiments, the RRC connection request message may include a RAN SET ID value for the previous RAN node (e.g., prior RAN node 404) to which the UE 401 was previously connected. As such, the UE 401 may provide the serving RAN node 402 with the RAN SET ID value that was assigned when the UE was connected to another RAN node previously, this might be pointing to the previous RAN node 404. The RAN node 402 may determine whether the RAN SET ID value provided by the UE 401 corresponds to an associated RAN SET ID value. In an instance, the RAN SET ID value provided by the UE 401 corresponds to an associated RAN SET ID value, the RAN node 402 may determine to access the RAN DB 403 associated with the RAN SET ID value. In some embodiments, the RRC connection request message may also include a 5G-S-TMSI or the equivalent 6G-S-TMSI value. The 5G-S-TMSI value or 6G-S-TMSI may be correlated to an international mobile subscriber identity (IMSI) in the RAN DB.

In operation 2 of FIG. 4A, the serving RAN node 402 may transmit a RRC connection setup message to a UE 401. As such, the RAN node 402 may establish a signaling radio bearer (SRB) along with SRB configuration information and thus allows use of a dedicated control channel (DCCH). In some embodiments, the RRC connection setup message may also contain configuration information for a physical uplink shared channel (PUSCH), physical uplink control channel (PUCCH), and/or physical downlink shared channel (PDSCH) as well as other configuration information. In some embodiments, the RRC connection setup message may include the UE identifier including RAN SET ID value for serving RAN node 401 or it may just include the RAN SET ID value. The UE 401 may store the RAN SET ID value such that it may provide this RAN SET ID value to one or more other RAN nodes it may attempt to connect to in the future.

In operation 3 of FIG. 4A, the UE 401 may transmit a RRC connection setup complete (also called RRC setup complete) message to serving RAN node 402. In some embodiments, the RRC connection setup complete message may confirm the successful completion of an RRC connection establishment.

In operation 4 of FIG. 4A, the serving RAN node 402 may retrieve RAN DB data from an associated RAN DB 403. In some embodiments, the RAN DB data may include UE context data related to UE 401. As described above, the RRC connection request message may include a RAN SET ID value for the previous RAN node (e.g., prior RAN node 404) to which the UE 401 was previously connected. In an instance, the RAN SET ID value provided by the UE 401 corresponds to an associated RAN SET ID value, the RAN node 402 may determine to access the associated RAN DB 403 associated with the RAN SET ID value to obtain UE context data.

In operation 5 of FIG. 4A, the serving RAN node 402 may transmit an RRC connection release with redirection message to UE 401. In some embodiments, the RRC connection release message may include a target cell identifier and a frequency such that the UE 401 is redirected to a new RAN node. In some embodiments, the RAN DB data retrieved in operation 4 may include one or more access stratum (AS) security keys and security contexts for UE 401. As such, serving RAN node 402 may obtain the AS security keys and security contexts for UE 401 without requesting them from AMF 405. The serving RAN node 402 may then encrypt the RRC connection release redirection message to UE 401 using the one or more AS security keys and security contexts obtained from the RAN DB 403.

Referring now to FIG. 4B, an alternative embodiment for exchanging connection request messages exchanged between a UE 401 and a serving RAN node 402 is illustrated.

In operation 1 of FIG. 4B, the UE 401 may transmit a RRC connection request message to a serving RAN node 402. This may be substantially similar to operation 2 as described with reference to FIG. 4A.

In operation 2 of FIG. 4B, the serving RAN node 402 may retrieve RAN DB data from an associated RAN DB 403. This may be substantially similar to operation 4 as described with reference to FIG. 4A. However, here should be appreciated that the serving RAN node 402 obtains the RAN DB data prior to transmitting a RRC connection setup message to the UE 401. As such, the serving RAN node 402 may obtain the UE context data and/or one or more AS keys corresponding to UE 401 earlier than as depicted in FIG. 4A.

In operation 3 of FIG. 4B, the serving RAN node 402 may transmit a RRC connection setup message to a UE 401. This may be substantially similar to operation 2 as described with reference to FIG. 4A. In some embodiments, the RRC connection setup message to UE 401 may be encrypted using the one or more AS keys corresponding to UE 401 obtained during operation 2.

In operation 4 of FIG. 4B, the UE 401 may transmit a RRC connection setup complete message to serving RAN node 402. This may be substantially similar to operation 3 as described with reference to FIG. 4A. In some embodiments, the RRC connection setup complete message to UE 401 may be encrypted using the one or more AS keys corresponding to UE 401 obtained during operation 2.

In operation 5 of FIG. 4B, the serving RAN node 402 may transmit a RRC connection release with redirection message to UE 401. This may be substantially similar to operation 5 as described with reference to FIG. 4A. In some embodiments, and as previously described, the RRC connection setup complete message to UE 401 may be encrypted using the one or more AS keys corresponding to UE 401 obtained during operation 2.

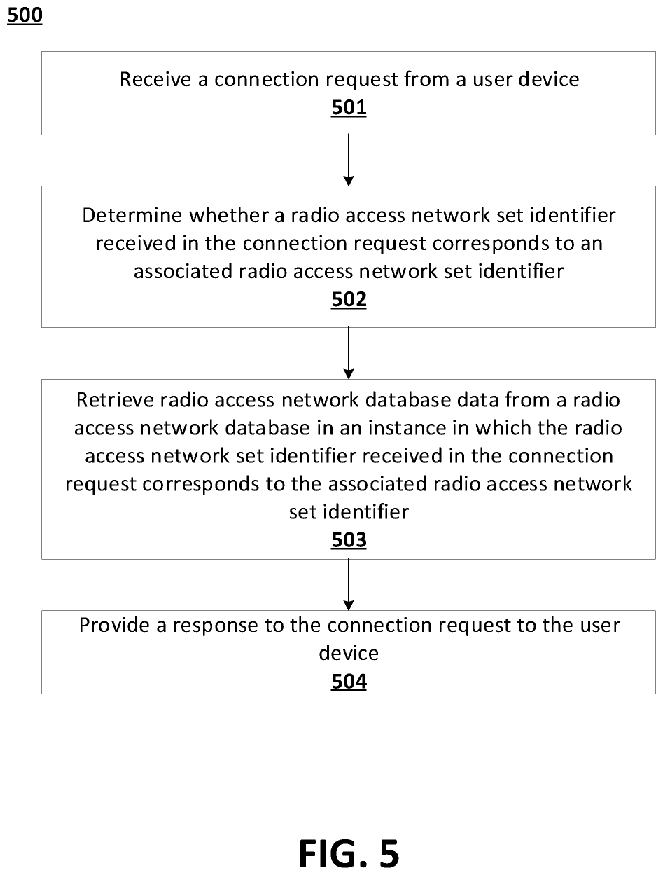

Referring now to FIG. 5, an example flowchart 500 implemented, for example, by an apparatus 300 embodied by a network entity, such as RAN node 202, to retrieve RAN DB data will be discussed herein.

As shown in block 501, the apparatus 300 embodied by a network entity, such as RAN node 202, may include means, such as the processor 302, the communication interface 304 or the like, for receiving a connection request from a UE. In some embodiments, the connection request from the user device may be an RRC connection request, such as that described with reference to FIGS. 4A-B. In some embodiments, the connection request includes at least a RAN SET ID value for the RAN node to which the UE was previously connected. In some embodiments, the connection request further includes a UE identifier, 5G-S-TMSI value, 6G-S-TMSI value and/or a C-RNTI value. The RAN SET ID value may be indicative of a RAN DB with which a RAN node previously connected with the UE is associated and the UE identifier provides the unique key to retrieve UE context from the respective RAN DB.

At block 502, the apparatus 300 embodied by a network entity, such as RAN node 202, may include means, such as the processor 302 or the like, for determining whether the RAN SET ID value received in the connection request corresponds to an associated RAN SET ID value. The RAN node 202 may be associated with a RAN SET ID value such that RAN node 202 may access at least a portion of the RAN DB data stored in the one or more associated RAN DBs. In some embodiments, the RAN SET ID may be associated with a hierarchy of one or more other RAN SET IDs. A higher hierarchical level RAN SET ID may include two or more lower hierarchical level RAN SET IDs such that the RAN DB associated with the higher hierarchical level RAN SET ID includes RAN DB data from each respective RAN DB associated with the two or more lower hierarchical level RAN SET IDs or instead of the data it includes a pointer to the lower level RAN DB where the data are stored. The RAN node 202 may determine whether the RAN SET ID value corresponding to the RAN node to which the UE was previously connected corresponds to an associated RAN SET ID value such that the RAN node 202 may access the UE context data stored in the RAN DB described by the RAN SET ID value.

At block 503, the apparatus 300 embodied by a network entity, such as RAN node 202, may include means, such as the processor 302, memory 306 or the like, for retrieving RAN DB data from the RAN DB associated with the RAN SET ID value in an instance in which the RAN SET ID value corresponds to the associated RAN SET ID value. In some embodiments, the retrieved RAN DB data includes at least UE context data for the associated UE from which a connection request was received. In some embodiments, the UE context data includes one or more AS keys and AS security context data for the associated user device. In some embodiments, the RAN DB data may additionally include one or more values for UE capabilities, UE timer settings, UE mobility behavior, location such as tracking area or cell ID, the RRC state including the radio bearer, quality of service information, network slice related information, as well as IP addresses and/or port numbers indicative of access core network functions, such as the AMF and/or user plane function (UPF). In some embodiments, the UE context data for the associated UE is retrieved prior to an initial setup context between a RAN node and a core network function, such as AMF 203.

In some embodiments, the RAN node 202 may determine the RAN DB data for the associated UE based at least in part on at least one of a UE identifier, C-RNTI value, 5G-S-TMSI value, 6G-S-TMSI value or a NGAP ID value. In some embodiments, a UE profile for the particular UE may be identified by a C-RNTI value, 5G-S-TMSI, 6G-S-TMSI value, or a NGAP ID value in the RAN DB. The RAN node 202 may receive the 5G-S-TMSI or 6G-S-TMSI value from the UE in the connection request described at block 501. This may be the 5G-S-TMSI or 6G-TMSI value assigned to the UE by a core network function, such as AMF 203. The core network function, such as AMF 203, may also assign a NGAP ID value to uniquely identify a UE during a globally unique temporary identifier (GUTI) allocation. The C-RNTI value may identify a RRC connection for a particular UE. In some embodiments, the core network function, such as AMF 203, may store the C-RNTI value, 5G-S-TMSI value or 6G-TMSI value, and/or NGAP ID value in RAN DB 204. The stored C-RNTI value, 5G-S-TMSI value or 6G-TMSI value, and/or NGAP ID value may be associated with UE context data for a particular UE such that the relevant UE context data may be associated with a C-RNTI value, 5G-S-TMSI value or 6G-TMSI value, and/or NGAP ID value. Additionally or alternatively, another unique identifier may be used to determine the UE context data for a particular UE. In some embodiments, the RAN node 202 may provide its associated RAN SET ID value to a core network function, such as AMF 203 during next generation application part (NGAP) connection setup such that the AMF 203 is aware of the RAN DB corresponding to the RAN node 202. As such, the RAN DB 204 may include RAN DB data provided by the AMF 203 to allow RAN node 202 to access such data without direct signaling to the RAN node 202.

In some embodiments, the RAN node 202 may store the retrieved RAN DB data in an associated memory, such as memory 306. As such, the RAN node may access the RAN DB data, including UE context data, without again retrieving it from the RAN DB.

In an instance in which the RAN SET ID value does not correspond to the associated RAN SET ID value, the RAN node 202 may not access the RAN DB. The RAN node 202 may attempt to obtain UE context data by requesting a UE context data transfer from one or more surrounding RAN nodes, such as via X2/Xn signaling. If the RAN node 202 is unable to obtain UE context data from one or more surrounding RAN nodes, the RAN node 202 may obtain UE context data from the AMF during the initial context setup.

At block 504, the apparatus 300 embodied by a network entity, such as RAN node 202, may include means, such as the processor 302, communication interface 304 or the like, for providing a response to the connection request to the user device. In some embodiments, the response to the connection request is secured based at least in part on the one or more AS keys associated with the UE. The one or more AS keys associated with the UE may be determined based at least in part on the UE context data. In some embodiments, the response to the connection request may be an RRC message, such as a RRC connection setup message and/or RRC connection release with redirection message as described with respect to FIGS. 4A-B.

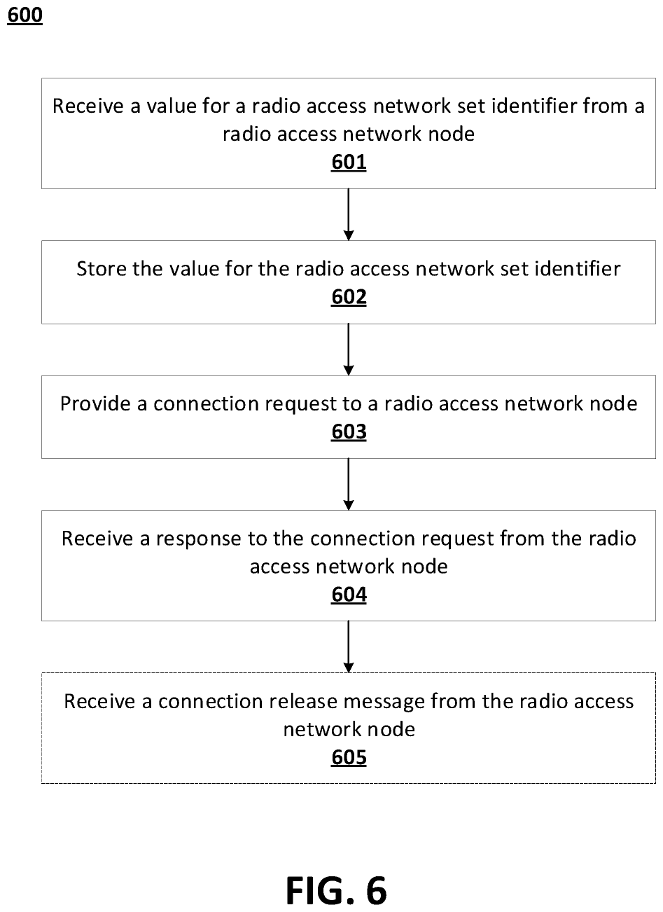

Referring now to FIG. 6, an example flowchart 600 implemented, for example, by an apparatus 300 embodied by a network entity, such as UE 201, to provide a connection request will be discussed herein.

As shown in block 601, the apparatus 300 embodied by a network entity, such as UE 201, may include means, such as the processor 302, the communication interface 304 or the like, for receiving a value for a RAN SET ID from a RAN node. In some embodiments, the UE 201 may receive the RAN SET ID value from the RAN node during a connection establishment procedure. The RAN SET ID value may be indicative of the RAN DB with which a RAN node previously connected with the UE 201 is associated.

As shown in block 602, the apparatus 300 embodied by a network entity, such as UE 201, may include means, such as the processor 302, memory 306, or the like, for storing the RAN SET ID value. As such, the UE 201 may provide the RAN SET ID value in future communications, such as during RRC signaling with a RAN node. In some embodiments, the RAN SET ID value received and stored by the UE may replace a previous RAN SET ID value received from a previous RAN node. In this way, the RAN SET ID value stored by the UE 201 is the RAN SET ID value associated with the RAN node with which the UE was most recently successfully connected.

As shown in block 603, the apparatus 300 embodied by a network entity, such as UE 201, may include means, such as the processor 302, memory 306, or the like, for providing a connection request to the RAN node. In some embodiments, the connection request includes at least a RAN SET ID value. The provided RAN SET ID value may be the RAN SET ID value stored by the UE 201. The RAN SET ID value may be indicative of the RAN DB, such as RAN DB 204 with which a RAN node previously connected with the UE 201 is stored. RAN DB 204 may therefore store UE context information associated with UE 201. In some embodiments, the connection request further includes a 5G-S-TMSI value or 6G-TMSI value and/or C-RNTI value. In some embodiments, the connection request may not include UE capability information, as may be conventionally provided. This may result in a smaller connection request message to be provided to the UE, thereby reducing network bandwidth usage.

In some embodiments, the connection request is provided to a second RAN node, that is different than the RAN node from which the RAN SET ID value was received at block 601. For example, this may occur when UE 201 traverses through a geographical area and moves out of the cell associated with the RAN node from which the RAN SET ID value was received at block 601 and into a new cell associated with the second RAN node. In some embodiments, the connection request is provided to the same RAN node as the RAN node from which the RAN SET ID value was received at block 601. For example, this may occur when UE 201 transitions from an idle status to a connected status and attempts to re-establish connection with the RAN node.

As shown in block 604, the apparatus 300 embodied by a network entity, such as UE 201, may include means, such as the processor 302, communication interface 304, memory 306, or the like, for receiving a response to the connection request from the RAN node. In some embodiments, the response to the connection request may be encrypted using one or more AS keys. In some embodiments, the response to the connection request may be one or more RRC messages, such as an RRC connection setup message. In some embodiments, the response to the connection request may include a new RAN SET ID value pertaining to an associated RAN SET ID value for the RAN node. The UE 201 may store the new RAN SET ID value as previously described with respected to block 601.

As shown in block 605, the apparatus 300 embodied by a network entity, such as UE 201, may include means, such as the processor 302, communication interface 304, memory 306, or the like, for receiving a connection release message from the RAN node. In some embodiments, the connection release message may include a target cell identifier and a frequency such that the UE 201 is redirected to a new RAN node. Such information or information about neighbor RAN nodes may also be stored in the RAN DB and obtained by the RAN node. In some embodiments, the connection release message may be encrypted using one or more AS keys. In some embodiments, the connection release message may be an RRC message, such as an RRC connection release message.

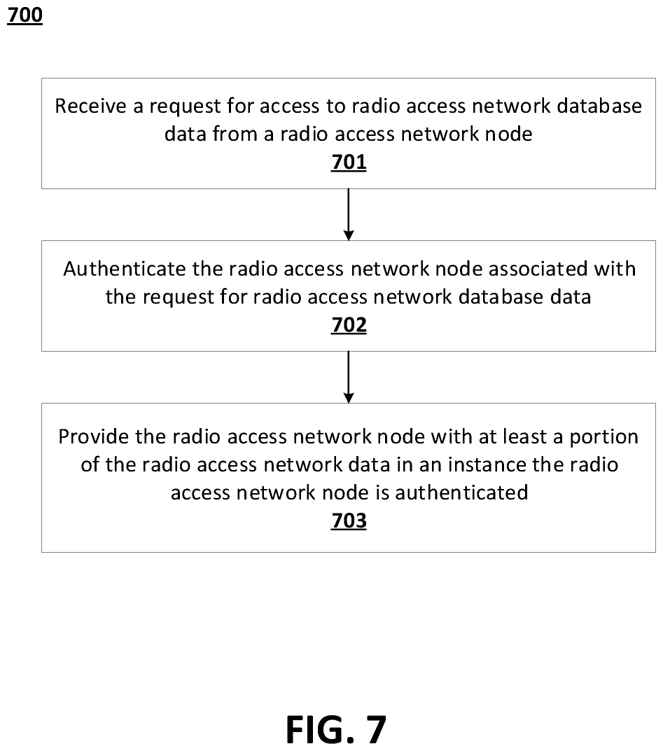

Referring now to FIG. 7, an example flowchart 700 implemented, for example, by an apparatus 300 embodied by a network entity, such as a RAN DB 204, to provide a RAN node with at least a portion of RAN DB data will be discussed herein.

As shown in block 701, the apparatus 300 embodied by a network entity, such as a RAN DB 204, may include means, such as the processor 302, the communication interface 304 or the like, for receiving a request for access to RAN DB data from a RAN node. In some embodiments, RAN DB 204 may receive a request from a RAN node for at least a portion of the RAN DB data stored in RAN DB 204. In some embodiments, the RAN DB 204 may receive the request for access to RAN DB data from a RAN node during a connection establishment process with a UE.

As shown in block 702, the apparatus 300 embodied by a network entity, such as a RAN DB 204, may include means, such as the processor 302, memory 306, or the like, for authenticating the RAN node associated with the request for RAN DB. In some embodiments, the RAN DB 204 may authenticate and authorize the request for RAN DB data based at least in part on RAN SET ID value associated with the RAN node. For example, a RAN node may be associated with a RAN SET ID value that is associated with the RAN DB 204. In an instance the RAN SET ID value is associated with the RAN DB 204, the RAN node may be authenticated and authorized. This may lead to establishing a secure connection between RAN node and RAN DB.

As shown in block 703, the apparatus 300 embodied by a network entity, such as a RAN DB 204, may include means, such as the processor 302, communication interface 304, memory 306, or the like, for providing the RAN node with at least a portion of the RAN DB data in an instance the RAN node is authenticated. In some embodiments, the RAN DB 204 may provide a RAN node with access to UE context data for a UE attempting to establish a connection with the RAN node. In some embodiments, the RAN DB 204 may also provide the RAN node with one or more of values for UE capabilities, UE timer settings, UE mobility behavior, location, the RRC state including the radio bearer, quality of service information, network slice related information, as well as IP addresses and/or port numbers indicative of access core network functions, such as the AMF and/or UPF.

In an instance, the RAN node is not authenticated, the RAN DB 204 may not provide the RAN node with any RAN DB data. The RAN node may not be authenticated in an instance the RAN SET ID value associated with the RAN node does not correspond to a particular RAN SET ID value associated with the RAN DB 204.

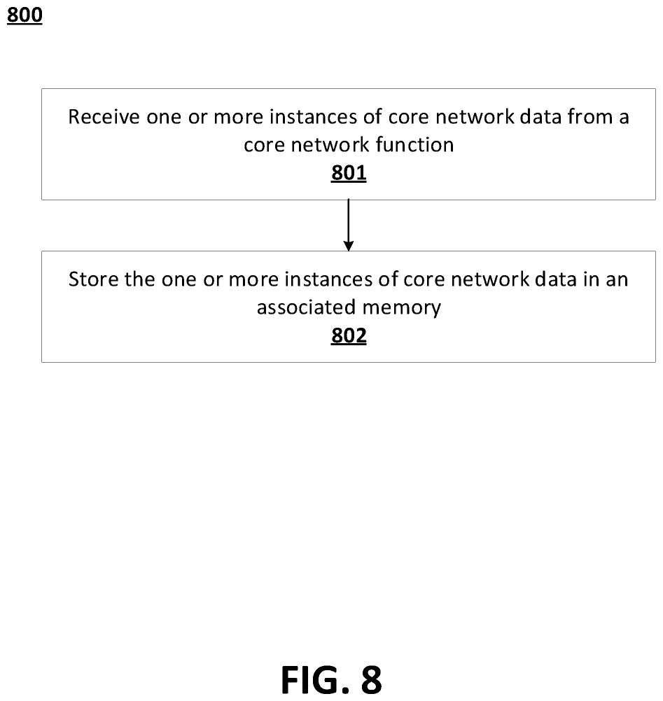

Referring now to FIG. 8, an example flowchart 800 implemented, for example, by an apparatus 300 embodied by a network entity, such as a RAN DB 204, to store one or more instances of core network data will be discussed herein.

As shown in block 801, the apparatus 300 embodied by a network entity, such as a RAN DB 204, may include means, such as the processor 302, the communication interface 304 or the like, for receiving one or more instances of core network data from a core network function. In some embodiments, the core network function may be an AMF, such as AMF 203. In some embodiments, the core network data may include IP addresses and/or port numbers indicative of access core network functions, such as the AMF and/or UPF. In some embodiments, the one or more instances of core network data may include values for a C-RTNI, 5G-S-TMSI, 6G-S-TMSI, and/or NGAP ID for a particular UE.

As shown in block 802, the apparatus 300 embodied by a network entity, such as a RAN DB 204, may include means, such as the processor 302, memory 306 or the like, for storing the one or more instances of core network data in an associated memory. In some embodiments, the RAN DB 204 may store the one or more instances of received core network data as associated with a particular UE profile in the RAN DB 204. For example, the RAN DB 204 may store UE context data for each individual UE and thus update the corresponding UE profile to include the one or more instances of received core network data. In some embodiments, the one or more instances of core network data may be stored globally such that they do not correspond to any one particular UE profile but are applicable to all UE profiles.

In some embodiments, the RAN DB 204 may identify each UE by an associated value for a C-RTNI, 5G-S-TMSI value or 6G-TMSI value, and/or NGAP ID associated with the UE. In an instance the RAN DB 204 receives a new value for the C-RTNI, 5G-S-TMSI value or 6G-TMSI value, and/or NGAP ID for a particular UE, the RAN DB 204 may update the UE profile to reflect the change in value such that the UE is now identifiable based on an updated value for the corresponding C-RTNI, 5G-S-TMSI value or 6G-TMSI value, and/or NGAP ID of the UE.

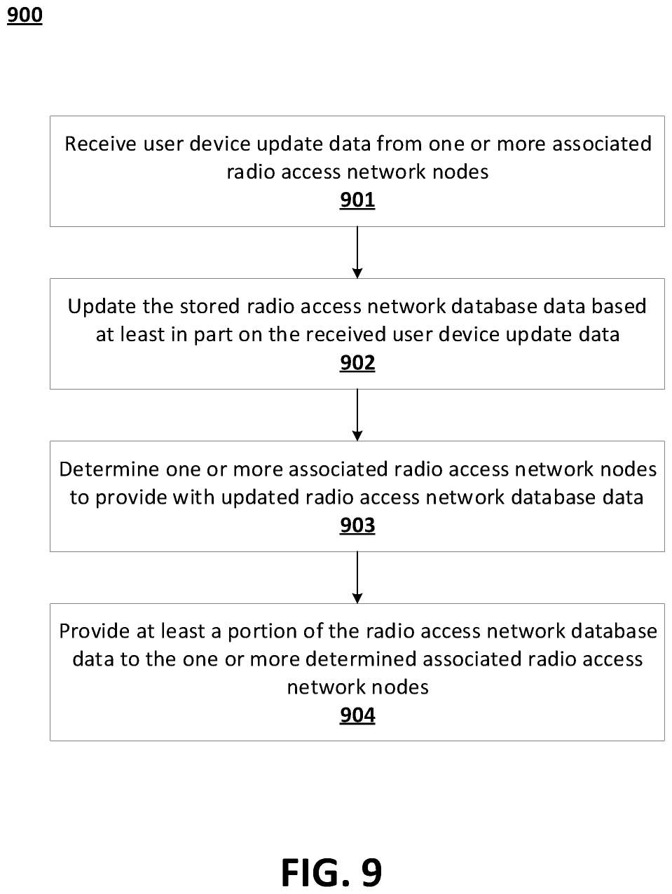

Referring now to FIG. 9, an example flowchart 900 implemented, for example, by an apparatus 300 embodied by a network entity, such as a RAN DB 204, for updating RAN DB data will be discussed herein.

As shown in block 901, the apparatus 300 embodied by a network entity, such as a RAN DB 204, may include means, such as the processor 302, the communication interface 304 or the like, for receiving UE update data from one or more associated RAN nodes. In some embodiments, the user device update data may include updated UE context data, such as updated UE capability information.

As shown in block 902, the apparatus 300 embodied by a network entity, such as a RAN DB 204, may include means, such as the processor 302, memory 306 or the like, for updating the stored RAN DB data based at least in part on the received UE update data. In some embodiments, the RAN DB 204 may update one or more values associated with a particular UE profile based at least in part on the received UE update data. As such, one or more values for a UE profile may be updated to reflect the most recent value associated with a particular UE.

As shown in block 903, the apparatus 300 embodied by a network entity, such as a RAN DB 204, may include means, such as the processor 302, memory 306 or the like, for determining one or more associated RAN nodes to provide with updated RAN DB data. In some embodiments, the RAN DB 204 may be configured to store a list of one or more associated RAN nodes. The one or more associated RAN nodes may be RAN nodes allowed to access at least part of the RAN DB data. In some embodiments, the list of one or more associated RAN nodes further includes one or more RAN node preferences. The one or more RAN node preferences may be indicative of when a RAN node would like to receive updated RAN DB data. For example, RAN node preferences may include, but are not limited to, immediate, periodic, and essential only. An immediate RAN node preference may indicate to the RAN DB 204 to immediately provide the particular RAN node with updated RAN DB data. A periodic RAN node preference may indicate to the RAN DB 204 to periodically provide the particular RAN node with updated RAN DB data. An essential only RAN node preference may indicate to the RAN DB 204 to only provide the particular RAN node with updated RAN DB data in an instance the updated RAN DB data is considered essential for the communication and/or functionality of the RAN node, UE, and/or RAN DB 204. For instance, the RAN node may have an associated time period and/or duration in which to receive RAN DB data updates, such as hourly, daily, weekly, bi-weekly, etc. As another example, the RAN node may have an associated time period in which to receive RAN DB data updates, such as 3 am. In some embodiments, the associated time period may be chosen during non-peak hours of network communication so as not to contribute to network signaling.

As shown in block 904, the apparatus 300 embodied by a network entity, such as a RAN DB 204, may include means, such as the processor 302, the communication interface 304 or the like, for providing at least a portion of the RAN DB data to one or more associated RAN nodes. Once the RAN DB 204 has determined the one or more associated RAN nodes to send RAN updated data, the RAN DB 204 may provide the one or more associated RAN nodes with the updated RAN DB data using one or more messages. The RAN DB 204 may provide the one or more associated RAN nodes with the updated RAN DB data based at least in part on the RAN node preferences for each associated RAN node. For example, the RAN DB 204 may determine to provide two RAN nodes with updated RAN DB data. A first RAN node may have an associated RAN node preference of immediately and the RAN DB 204 may provide the first RAN node with the updated RAN DB data immediately. A second RAN node may have an associated RAN node preference of periodically at 3 am daily and the RAN DB 204 may provide the second RAN node with the updated RAN DB data at 3 am.

As described above, a method, apparatus, and computer program product are disclosed for improving the resiliency support in the RAN by providing for UE context data accessible to one or more RAN nodes. By storing RAN DB data, including UE context data, in a RAN DB, such as RAN DB 204, the UE context data may be accessible to one or more RAN nodes or other RAN DBs, such that the RAN DB is able to provide a RAN node, such as a gNB 202, with UE context prior to initial context setup procedures with a core network function, such as AMF 203, during connection procedures with a UE, such as UE 201. Additionally, when a UE changes modes, such as going from an idle mode to a connected mode, the UE context data may be retrieved from the RAN DB such that an initial context setup with the RAN node and core network function is not necessary. In this way, the resiliency support in the network is improved by reducing the need for network signaling between the RAN node and AMF, RAN node and UE, and between RAN nodes, and thus also reducing overall network bandwidth usage. Furthermore, the UE context data may include one or more AS keys for UE 201, such that the RAN node 202 may more securely communicate with UE 201 without requesting the AS keys from the core network function 203. As such, communications between the RAN node 202 and UE 201 may be encrypted and secured earlier on in the communication process, resulting in an overall more secure communication network.

FIGS. 4-9 illustrate message flows and flow charts depicting methods according to an example embodiment of the present invention. It will be understood that each block of the message flow may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 306 of an apparatus 300 employing an embodiment of the present invention and executed by a processor 302. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts and message flows support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

Although a few variations have been described in detail above, other modifications or additions are possible. In particular, further features and/or variations may be provided in addition to those set forth herein. Moreover, the implementations described above may be directed to various combinations and sub-combinations of the disclosed features and/or combinations and sub-combinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

It should therefore again be emphasized that the various embodiments described herein are presented by way of illustrative example only and should not be construed as limiting the scope of the claims. For example, alternative embodiments can utilize different communication system configurations, user equipment configurations, base station configurations, identity request processes, messaging protocols and message formats than those described above in the context of the illustrative embodiments. These and numerous other alternative embodiments within the scope of the appended claims will be readily apparent to those skilled in the art.

1. An apparatus comprising:
at least one processor; and
at least one memory including computer program code,
the at least one memory and the computer program code configured to, with the at least one processor, cause the apparatus at least to perform:
receive, from a user device, a connection request, wherein (i) the connection request comprises at least a radio network set identifier that is indicative of at least a radio network set or a radio network database, (ii) the radio access network set identifier is indicative of a radio access network database with which a radio access network node previously connected with the user device is associated, (iii) the radio access network database is associated with one or more radio access network nodes, and (iv) the radio access network database is configured to store at least user device context data for one or more user devices associated with the one or more radio access network nodes associated with the radio access network database;
determine whether the radio access network set identifier received in the connection request corresponds to an associated radio access network set identifier; and
in an instance in which the radio access network set identifier received in the connection request corresponds to the associated radio access network set identifier, retrieve radio access network database data from the radio access network database associated with the radio access network set identifier, wherein the radio access network database data comprises at least user device context data for the associated user device.

2. The apparatus of claim 1, wherein the user device context data for each of the one or more user devices comprises one or more access stratum security keys or in general, security contexts associated with the user device.

3. The apparatus of claim 2, wherein the at least one memory and the computer program code are further configured to, with the at least one processor, cause the apparatus to perform:
provide, to the user device, a response to the connection request, wherein the response to the connection request is secured based at least in part on the one or more access stratum security keys associated with the user device.

4. The apparatus of claim 1, wherein the at least one memory and the computer program code are further configured to, with the at least one processor, cause the apparatus to perform:
determine the radio access network database data for the associated user device based at least in part on at least one of (i) a cell radio network temporary identity, (ii) 5G-S-temporary mobile subscriber identity, (iia) 6G-S-temporary mobile subscriber identity (iii) a next generation application part user device identifier or (iv) any radio access network based user device identifier.

5. The apparatus of claim 1, wherein the user device context for the user device is retrieved prior to an initial setup context between a radio access network node and an access management function

6. The apparatus of claim 1, wherein the at least one memory and the computer program code are further configured to, with the at least one processor, cause the apparatus to perform:
provide, to a central network function, one or more assigned radio access network set identifiers.

7. The apparatus of claim 1, wherein the at least one memory and the computer program code are further configured to, with the at least one processor, cause the apparatus to perform:
store at least a portion of the radio access network database data in an associated memory.

8. The apparatus of claim 1, wherein the radio access network database further comprises data from an associated core network.

9. The apparatus of claim 1, wherein the radio access network set identifier is associated with a hierarchy of one or more other radio access network set identifiers.

10. The apparatus of claim 1, wherein one radio network database obtains user device context data from another radio network database using the radio network set identifier or radio network database identifier to determine the other radio network database.

11. The apparatus of claim 1, wherein a radio access network node authenticates and authorizes itself prior to obtaining data from a radio network database in a secure manner.

12. The apparatus of claim 1, wherein the radio access network database is further configured to store data of pertaining to neighboring radio access network nodes related to a given radio access network node.

13. An apparatus comprising:
at least one processor; and
at least one memory including computer program code,
the at least one memory and the computer program code configured to, with the at least one processor, cause the apparatus at least to perform:
receive, from a radio access network node, a radio access network set identifier;
store the radio access network set identifier; and
provide a connection request to a radio access network node, wherein (i) the connection request comprises at least a radio access network set identifier or radio access network database identifier, (ii) the radio access network set identifier is indicative of a radio access network database with which a radio access network node previously connected with the apparatus is associated, (iii) the radio access network database is associated with one or more radio access network nodes, and (iv) the radio access network database is configured to store at least user device context data for one or more user devices associated with the one or more radio access network nodes associated with the radio access network database.

14. The apparatus of claim 13, wherein the connection request is provided to a second radio access network node, different than the radio access network node from which the radio access network set identifier was received.

15. The apparatus of claim 13, wherein the connection request further comprises a 5G-S-temporary mobile subscription identifier or 6G-S-temporary mobile subscription identifier.

16. The apparatus of claim 13, wherein the received radio access network set identifier is indicative of a radio access network database with which a radio access network node previously connected and with the user device is associated.

17. The apparatus of claim 13, the at least one memory and the computer program code further configured to, with the at least one processor, cause the apparatus to perform:
receive, from the radio access network node, a connection release signal, wherein the connection release signal redirects the connection to a different frequency, cell, radio access network node, and wherein the connection release signal is encrypted based at least in part using stored associated access stratum security keys.

18. The apparatus of claim 13, wherein the connection request further comprises at least a user device identifier, the user device identifier serves as unique key for the radio access network node to retrieve user device context data from the radio access network database.

19. A computer program product comprising at least one non-transitory computer-readable storage medium having computer executable program code instructions stored therein with the computer executable program code instructions including program code instructions configured, upon execution, to:
receive, from a radio access network node, a request for access to at least a portion of radio access network database data, wherein the request for access comprises at least a radio access network set identifier associated with the radio access network node; and
provide the radio access network node with at least a portion of the radio access network database data including user device context data for one or more user devices associated with the radio access network node.

20. The computer program of claim 19, the computer executable program code instructions including program code instructions further configured, upon execution, to:
authenticate and authorize the radio access network node associated with the request for radio access network database data based at least in part on a radio access network set identifier associated with the radio access network node;
establish a secure connection with the radio access network node; and
provide the radio access network node with at least a portion of the radio access network database data including user device context data for one or more user devices associated with the radio access network node in an instance the radio access network node is authenticated and authorized.

21-25. (canceled)
